(19) United States
(12) Patent Application Publication
(10) Pub. No.: US 2008/0179559 A1
(43) Pub. Date: Jul. 31, 2008

(54) VALVE CARTRIDGE WITH SNAP RETAINER TOLERANCE ABSORBER

(75) Inventor: Mark S. Kacik, Strongsville, OH (US)

Correspondence Address: CALFEE HALTER & GRISWOLD, LLP, 800 SUPERIOR AVENUE, SUITE 1400, CLEVELAND, OH, 44114, US

(73) Assignee: Moen Incorporated, North Olmsted, OH (US)

(21) Appl. No.: 12/023,806

(22) Filed: Jan. 31, 2008

Related U.S. Application Data
(60) Provisional application No. 60/898,451, filed on Jan. 31, 2007.

(51) Int. Cl. F16K 5/00; F16K 27/00; F16K 31/60

(52) U.S. Cl. 251/231; 251/366; 251/314

(57) ABSTRACT

A two-handle valve cartridge has a housing with a snap retainer formed therein, such that a stem can be snap fit into the housing. The snap retainer prevents the stem from inadvertently becoming dislodged after assembly of the valve cartridge. The snap retainer also absorbs tolerances attributable to the stem and the housing and eliminates a clearance between the stem and the housing.

### RELATED APPLICATION

The present application is being filed as a non-provisional patent application claiming priority under 35 U.S.C. §119(e) from, and any other benefit of, U.S. Provisional Patent Application No. 60/898,451 filed on Jan. 31, 2007, the entire disclosure of which is herein incorporated by reference.

### FIELD

The invention relates generally to valve cartridges and, more particularly, to a valve cartridge having integral structure for retaining an actuating mechanism in the valve cartridge, absorbing tolerances in the valve cartridge and eliminating a clearance between the actuating mechanism and a housing of the valve cartridge.

### BACKGROUND

Typically, for a plumbing fixture (e.g., a faucet, a tub spout, a shower head), a valve body conveys water flowing from a main water source to a desired destination (e.g., a sink, a tub, a basin). The valve body generally has two water inlet passages through which cold water and hot water from the main water source can respectively flow. The valve body also has a water outlet passage through which the cold water, the hot water or a mixture of the cold and hot water can be discharged to an outlet portion of the plumbing fixture (e.g., a spout).

In a two-handle version of the valve body, the valve body has two cavities for receiving a first valve cartridge and a second valve cartridge, respectively. The first valve cartridge allows the user to control the flow rate of the cold water flowing through the water inlet passage carrying the cold water using a first valve actuating mechanism. Similarly, the second valve cartridge allows the user to control the flow rate of the hot water flowing through the water inlet passage carrying the hot water using a second valve actuating mechanism. The first valve cartridge and the second valve cartridge function independently of one another. Accordingly, the user can cause only the cold water, only the hot water or a mixture of the cold water and the hot water to be discharged through the water outlet passage of the valve body by using the first valve actuating mechanism, the second valve actuating mechanism or both the first and second valve actuating mechanisms, respectively.

One type of valve cartridge is a structural assembly including a housing in which a pair of disks, plates or the like is disposed. The disks are made of a hard material (e.g., ceramic or metal). One of the disks (i.e., a fixed disk) is fixed with respect to the housing. The other disk (i.e., a movable disk) is disposed above the fixed disk and is movable with respect to the fixed disk. The valve cartridge includes the actuating mechanism that is directly or indirectly connected at one end to the movable disk. Another end of the actuating mechanism extends through an opening in the housing for manipulation by the user. The end of the actuating mechanism extending through the opening in the housing can be connected to a handle, knob or the like to assist the user in operating the valve cartridge.

In a two-handle version of this type of valve cartridge for use in the two-handle version of the valve body, the valve cartridge only controls the flow rate of either the cold water or the hot water. Thus, the valve cartridge includes a single inlet opening (i.e., either a cold water inlet opening or a hot water inlet opening) at a lower end of the housing that substantially aligns with a corresponding water inlet passage of the valve body when the valve cartridge is installed in the valve body. The valve cartridge also includes one or more outlet openings (e.g., in the side of the housing) that substantially align with a corresponding water outlet passage of the valve body when the valve cartridge is installed in the valve body.

In the two-handle valve cartridge, the fixed disk is disposed above the inlet opening in the housing and the movable disk is disposed above the fixed disk. The actuating mechanism is connected to the movable disk such that rotation of the actuating mechanism by the user causes the movable disk to rotate relative to the fixed disk. The fixed disk and the movable disk have apertures such that the movable disk rotates between a fully closed position where the movable disk completely blocks the apertures in the fixed disk and a fully open position where the apertures in both disks are fully aligned.

By installing a pair of the two-handle valve cartridges in the two-handle version of the valve body, a user can separately control the flow rate (i.e., from zero to a maximum value) of both the cold water and the hot water, independently. The user can vary the temperature of the water being discharged through the water outlet passage of the valve body by varying the flow rate of the cold water or the hot water which, in turn, varies the proportion of the cold water to the hot water in the mixture to achieve varying degrees of warm water.

In a conventional two-handle valve cartridge, the internal components of the valve cartridge are often merely friction fit into the valve cartridge during assembly. For example, a lower seal can be friction fit into a housing of the valve cartridge to retain the lower seal and those internal components disposed above the lower seal in the housing. Accordingly, any inadvertent pressure placed on the valve cartridge prior to installation in a valve body can be sufficient to overcome the friction fit of the internal components, thereby causing the internal components to become dislodged from the housing. For example, an actuating mechanism of the valve cartridge has an end that extends through an opening in the housing of the valve cartridge. Thus, if pressure is placed on the end of the actuating mechanism extending out of the housing, such as during shipment of the valve cartridge, the actuating mechanism (along with the other internal components) can become dislodged from the housing. Consequently, a clip is attached to the end of the actuating mechanism extending outside the housing of the valve cartridge to hold the actuating mechanism in the housing of the valve cartridge. In this manner, the clip prevents the actuating mechanism from becoming dislodged prior to installation of the valve cartridge in the valve body.

The clip, however, represents an additional part that needs to be manufactured, managed and maintained. Accordingly, the clip increases an overall cost of the valve cartridge. Furthermore, the clip further complicates the assembly process of the valve cartridge.

Additionally, in the conventional two-handle valve cartridge, the dimensional characteristics of the actuating mechanism and the housing (i.e., a central bore of the housing) can vary from cartridge to cartridge. Accordingly, there are tolerances with respect to the actuating mechanism and the housing that need to be accounted for because of these varying dimensional characteristics. Further, based on these tolerances, a size of an annular gap that exists between the actuating mechanism and an inner surface of the housing will vary. As a result of the tolerances attributable to the actuating mechanism and the housing, as well as the presence of the gap (i.e., the clearance between the actuating mechanism and the housing), the actuating mechanism can move radially within the housing such that an inconsistent, imprecise and/or loose feel is experienced during operation of the actuating mechanism of the valve cartridge.

The conventional two-handle cartridge does not have integral structure for absorbing the tolerances of the actuating mechanism and/or the housing of the valve cartridge. Furthermore, the conventional two-handle cartridge does not have integral structure for eliminating the clearance between the actuating mechanism and the housing of the valve cartridge.

Accordingly, there is a need in the art for a valve cartridge having integral structure for retaining an actuating mechanism in a housing of the valve cartridge after the valve cartridge is assembled, absorbing tolerances in the valve cartridge attributable to the actuating mechanism and the housing and/or eliminating a clearance between the actuating mechanism and the housing.

### SUMMARY

In view of the above, it is an exemplary aspect to provide a valve cartridge with integral structure for retaining an actuating mechanism of the valve cartridge in a housing of the valve cartridge after the valve cartridge is assembled.

It is another exemplary aspect to provide a valve cartridge with integral structure for absorbing tolerances attributable to an actuating mechanism and/or a housing of the valve cartridge.

It is still another exemplary aspect to provide a valve cartridge with integral structure that eliminates a clearance between a portion of an actuating mechanism of the valve cartridge and a portion of an inner surface of a housing of the valve cartridge.

### BRIEF DESCRIPTION OF THE DRAWINGS

The above aspects and additional aspects, features and advantages will become readily apparent by describing in detail exemplary embodiments thereof with reference to the attached drawings, wherein like reference numerals denote like elements, and:

FIG. 1 is an exploded perspective view of a valve cartridge, according to an exemplary embodiment.

FIG. 2 is a perspective view of an exemplary temperature limit device of the exemplary valve cartridge of FIG. 1.

FIGS. 3A-3D show an exemplary housing used in the exemplary valve cartridge of FIG. 1. FIG. 3A is a perspective view of the housing. FIG. 3B is a side elevational view of the housing. FIG. 3C is a bottom view of the housing. FIG. 3D is a cross-sectional view of the housing of FIG. 3C, along line A-A.

FIGS. 4A-4B show an exemplary stem used in the exemplary valve cartridge of FIG. 1. FIG. 4A is a perspective view of the stem. FIG. 4B is another perspective view of the stem.

FIGS. 5A-5C show an exemplary sealing disk used in the exemplary valve cartridge of FIG. 1. FIG. 5A is a top perspective view of the sealing disk. FIG. 5B is a side elevational view of the sealing disk. FIG. 5C is a bottom perspective view of the sealing disk.

FIGS. 6A-6C show an exemplary fixed disk used in the exemplary valve cartridge of FIG. 1. FIG. 6A is a top perspective view of the fixed disk. FIG. 6B is a plan view of the fixed disk. FIG. 6C is a bottom perspective view of the fixed disk.

FIG. 7 is a perspective view of an exemplary base seal of the exemplary valve cartridge of FIG. 1.

FIGS. 8A-8E show the exemplary valve cartridge of FIG. 1 in assembled form. FIG. 8A is a perspective view of the valve cartridge in assembled form. FIG. 8B is a side elevational view of the valve cartridge in assembled form. FIG. 8C is a plan view of the valve cartridge in assembled form. FIG. 8D is a cross-sectional view of the valve cartridge of FIG. 8C, along line A-A. FIG. 8E is a cross-sectional view of the valve cartridge of FIG. 8C, along line B-B.

FIGS. 9A-9B show an exemplary snap retainer used in the exemplary valve cartridge of FIG. 1. FIG. 9A is a detail view of the snap retainer of FIG. 8D. FIG. 9B is an increased detail view of the snap retainer of FIG. 8D.

FIGS. 10A-10B show the exemplary valve cartridge of FIG. 1 in assembled form after installation in a plumbing fixture. FIG. 10A is a cross-sectional view (along line B-B in FIG. 8C) of the exemplary valve cartridge of FIG. 1 after installation in the plumbing fixture. FIG. 10B is another cross-sectional view (along line B-B in FIG. 8C) of the exemplary valve cartridge of FIG. 1 after installation in the plumbing fixture.

### DETAILED DESCRIPTION

While the general inventive concept is susceptible of embodiment in many different forms, there are shown in the drawings and will be described herein in detail specific embodiments thereof with the understanding that the present disclosure is to be considered as an exemplification of the principles of the general inventive concept. Accordingly, the general inventive concept is not intended to be limited to the specific embodiments illustrated herein.

A two-handle valve cartridge 100, according to an exemplary embodiment, has integral structure for retaining an actuating mechanism (e.g., a stem 102) in a housing 104 after assembly of the valve cartridge 100. The integral structure of the valve cartridge 100 also compensates for tolerances attributable to the stem 102 and/or a central bore 106 of the housing 104 in the valve cartridge 100. The integral structure also eliminates a clearance between a portion of the stem 102 and a portion of the central bore 106 of the housing 104 in the valve cartridge 100.

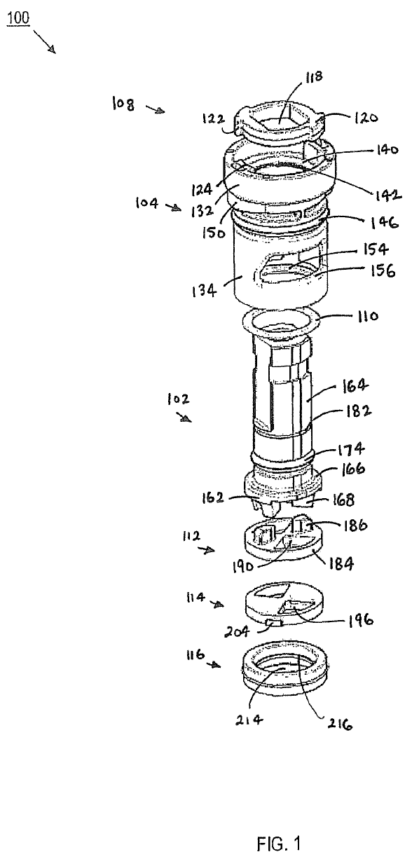

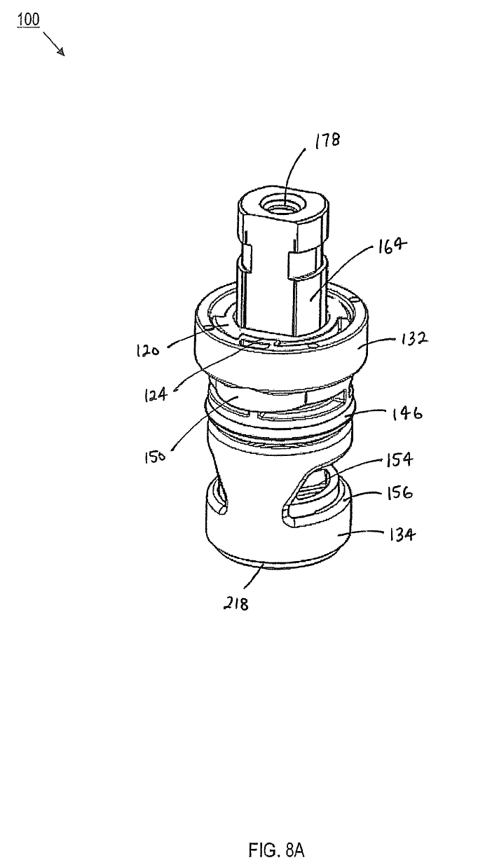

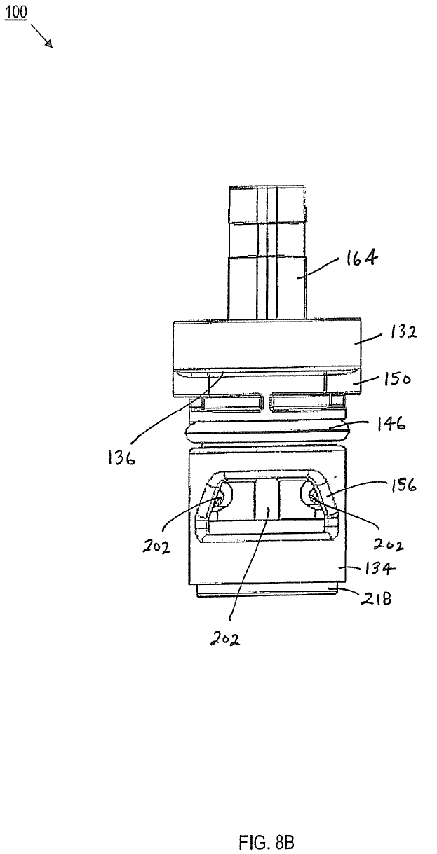

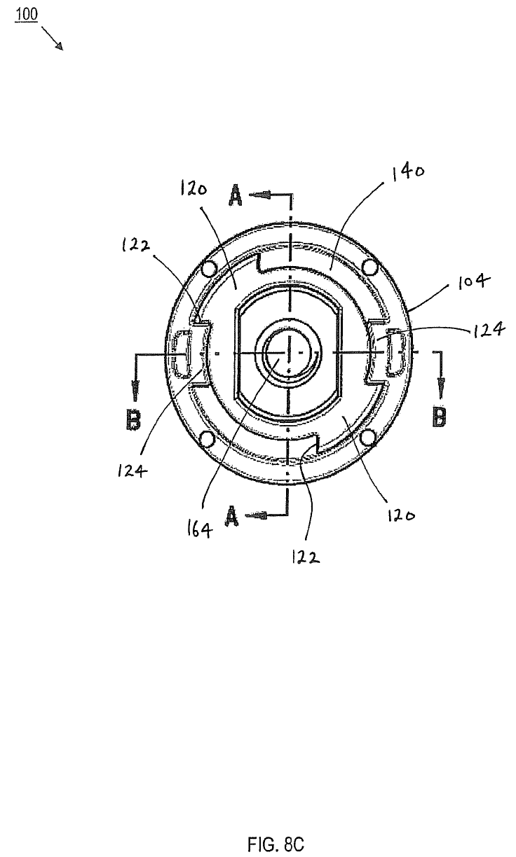

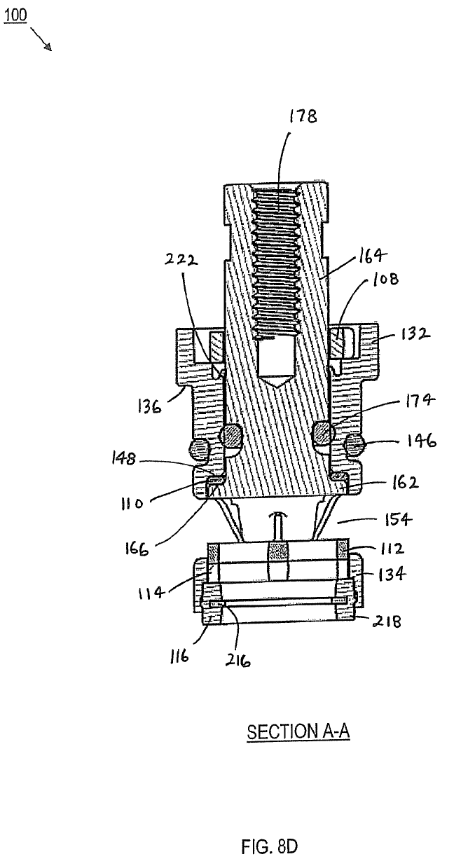

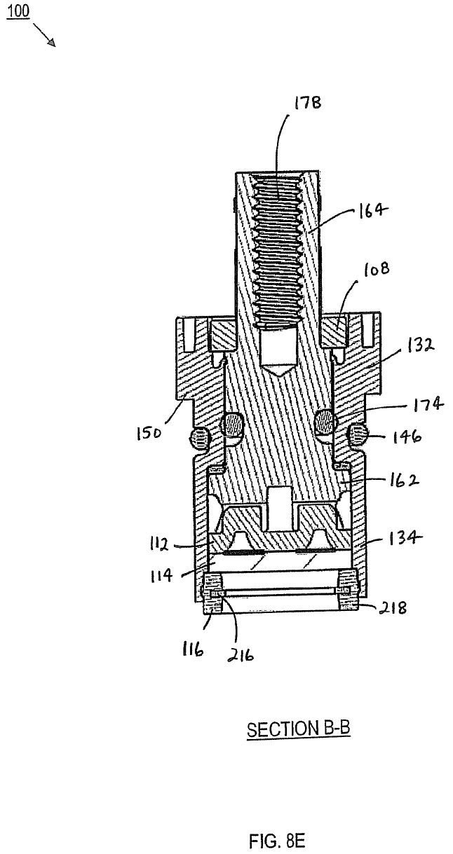

As shown in FIGS. 1 and 8A-8E, the valve cartridge 100 includes a temperature limit device 108, the housing 104, a washer 110, the stem 102, a sealing disk 112, a fixed disk 114 and a base seal 116. The sealing disk 112 and/or the fixed disk 114 can be made of a hard material. For example, the sealing disk 112 and/or the fixed disk 114 can be made of ceramic or stainless steel. The housing 104, for example, can be made of plastic or metal.

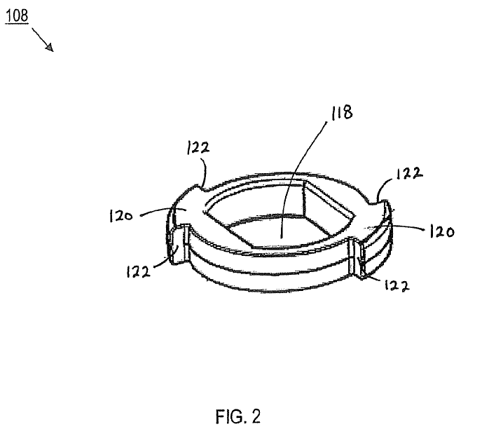

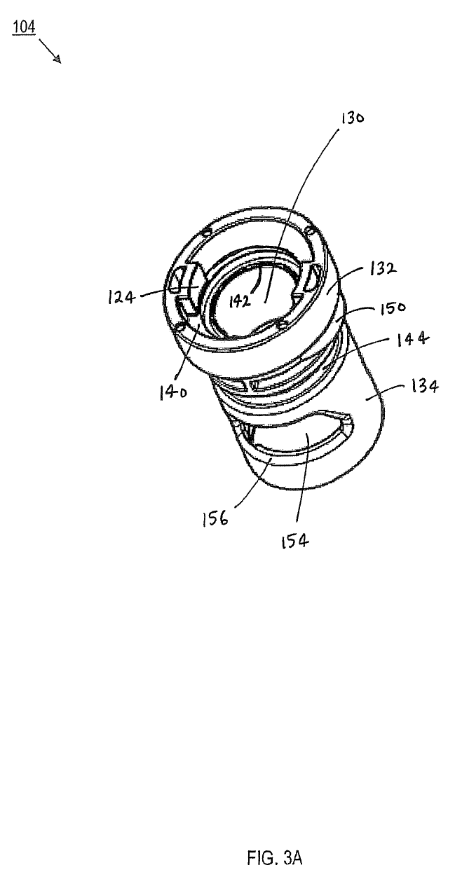

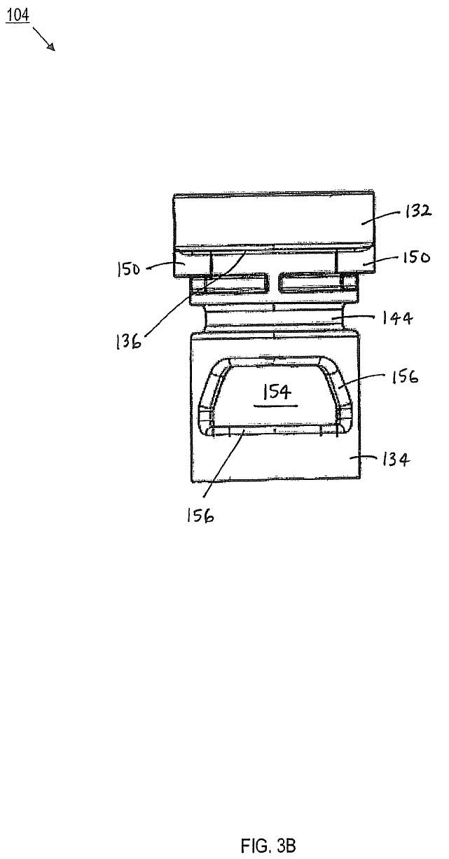

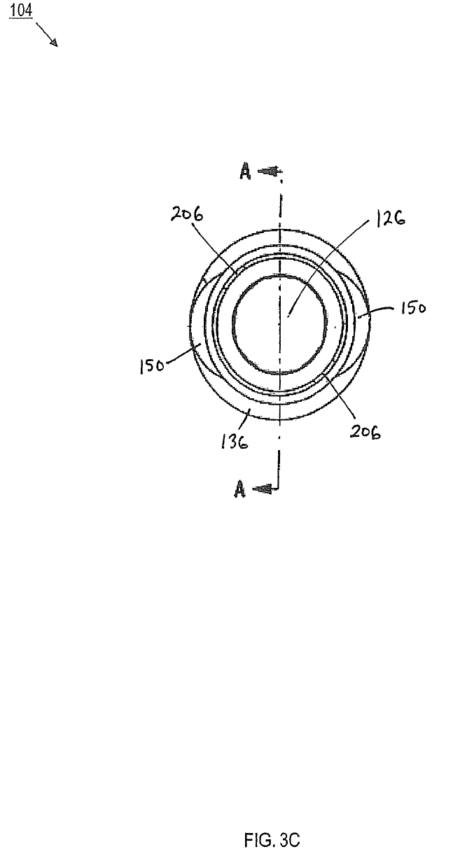

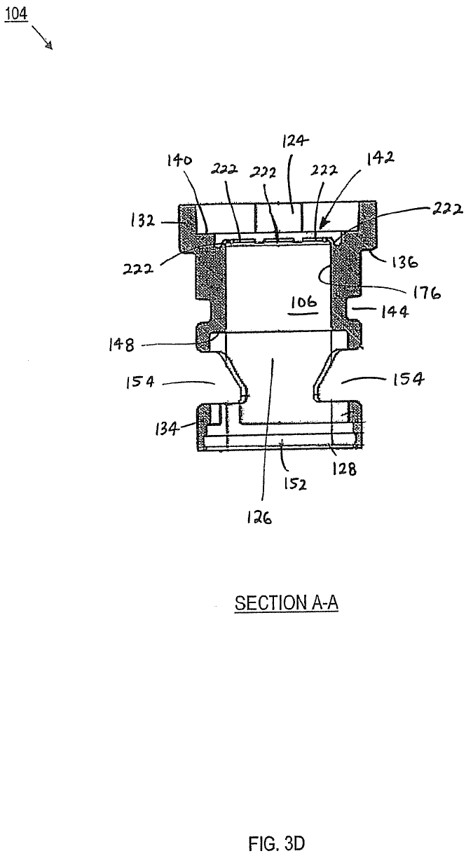

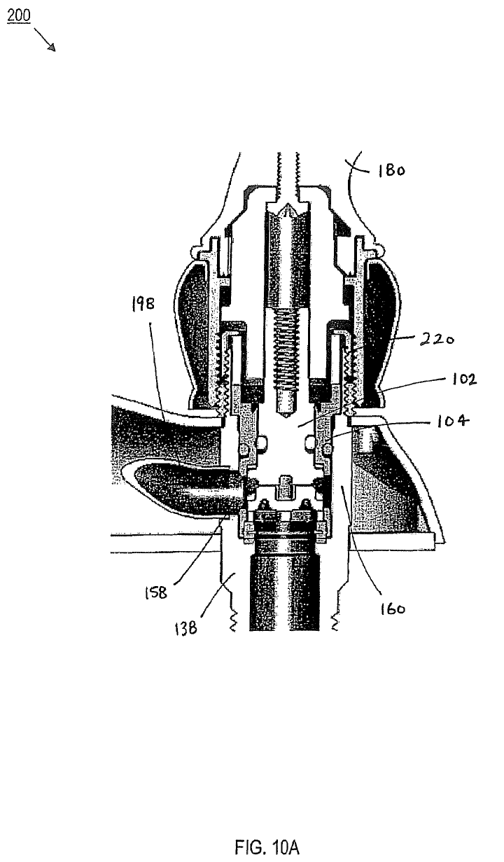

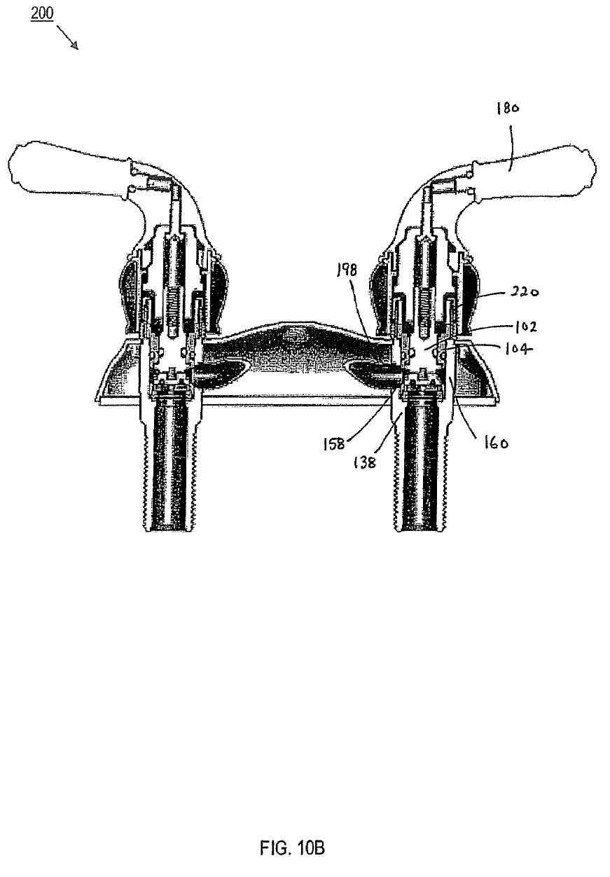

As shown in FIG. 2, the temperature limit device 108 has a generally annular shape with a central opening 118. A shape of the central opening 118 corresponds to a shape of the stem 102, such that the temperature limit device 108 fits over the stem 102. Accordingly, the temperature limit device 108 rotates with the stem 102. The temperature limit device 108 includes two stop projections 120 formed on opposing sides of the temperature limit device 108. Each of the stop projections 120 has a pair of stop ends 122. The stop ends 122 engage stop tabs 124 formed on the housing 104 (see FIG. 3A) to limit the range of rotation of the stem 102 relative to the housing 104. In this manner, the temperature limit device 108 functions to limit the flow rate of the (cold or hot) water flowing through the valve cartridge 100 and, thus, limit the maximum temperature of the mixed water. It will be appreciated that the temperature limit device 108 need not be a discrete component. For example, the temperature limit device 108 could be formed as part of an operating member 180 (e.g., a handle, knob, lever) for connecting to the stem 102 (see FIGS. 10A-10B).

As shown in FIGS. 3A-3D, the housing 104 has a cavity 126 formed therein for receiving the remaining components of the valve cartridge 100. The cavity 126 includes the central bore 106 that extends through the housing 104. The housing 104 includes a lower opening 128 through which the components can be inserted into the housing 104. For example, the washer 110, the stern 102, the sealing disk 112, the fixed disk 114 and the base seal 116 are inserted into the housing 104 through the lower opening 128. The housing 104 also includes an upper opening 130 through which a portion of the stem 102 extends.

The housing 104 has an upper portion 132 that includes the upper opening 130 and a lower portion 134 that includes the lower opening 128. An outer diameter of the upper portion 132 is greater than an outer diameter of the lower portion 134. As a result, a seating shoulder 136 is defined where the upper portion 132 joins the lower portion 134. The seating shoulder 136 rests on a ledge of a valve body 138 in which the valve cartridge 100 is installed, such that only the lower portion 134 of the housing 104 sits inside the valve body 138 (see FIGS. 10A-10B).

A diameter of the cavity 126 in the upper portion 132 of the housing 104 near the upper opening 130 is greater than a diameter of the cavity 126 in the lower portion 134 of the housing 104 near the lower opening 128. The temperature limit device 108 surrounding the stem 102 fits inside the cavity 126 in the upper portion 132 of the housing 104 and rests on a first inner ledge 140 formed above where the upper portion 132 joins the lower portion 134. The stop tabs 124 are formed on the first inner ledge 140 and limit how far the temperature limit device 108 and, thus, the stem 102 can rotate.

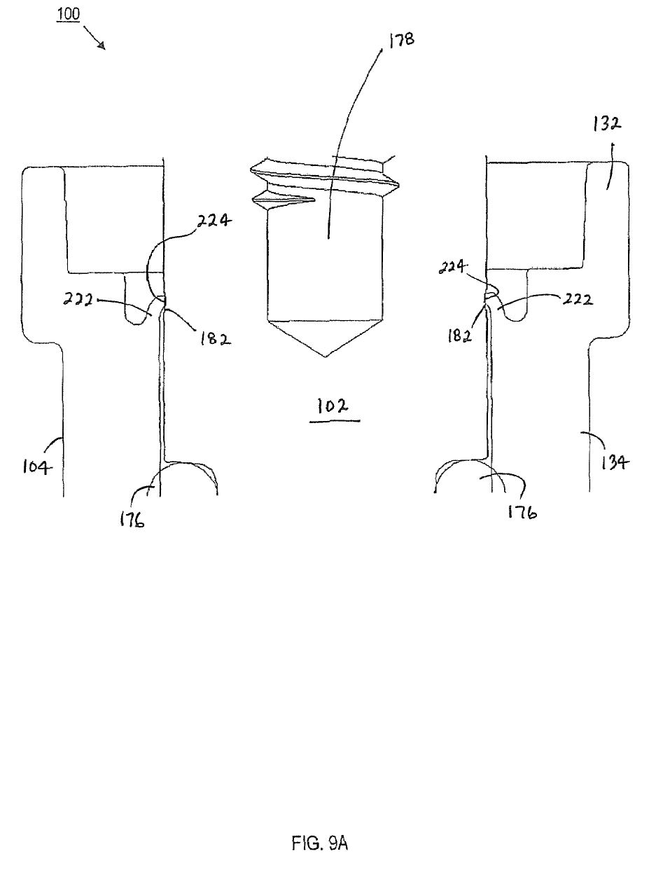

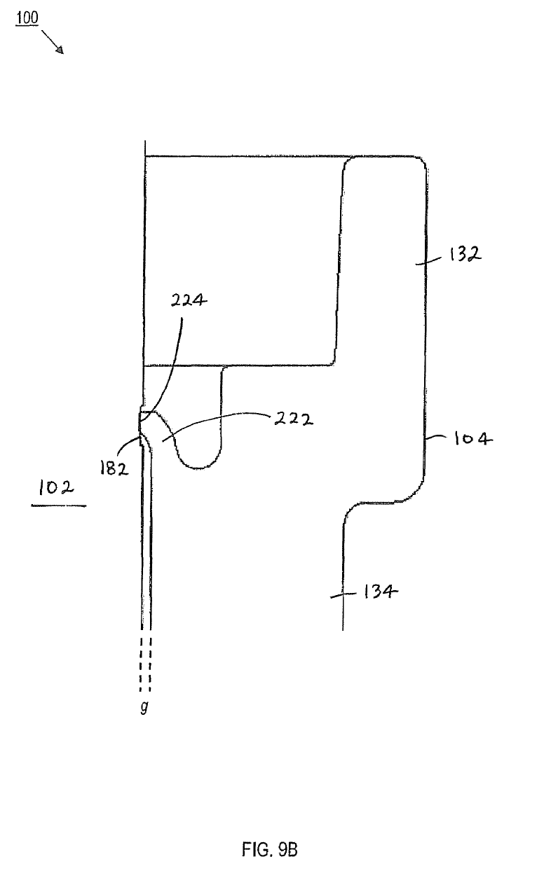

A snap retainer 142 is formed integrally with the housing 104 (see FIGS. 9A-9B). In one exemplary embodiment, the snap retainer 142 is formed inside the housing 104. For example, the snap retainer 142 is formed in the central bore 106 of the housing 104 between the seating shoulder 136 of the housing 104 and the first inner ledge 140 of the housing 104 (see FIG. 3D). The snap retainer 142 engages the stem 102, as described below.

A groove 144 for receiving an external seal 146 (e.g., an O-ring) is formed on an outer surface of the lower portion 134 of the housing 104. The external seal 146 forms a water tight seal between an outer surface of the housing 104 and the valve body 138 (see FIGS. 10A-10B). A diameter of the cavity 126 in the lower portion 134 of the housing 104 near the lower opening 128 is greater than a diameter of the cavity 126 in the lower portion 134 of the housing 104 below the seating shoulder 136. Consequently, a second inner ledge 148 is formed in the lower portion 134 of the housing 104 below the groove 144.

One or more keys 150 are formed on an outer surface of the lower portion 134 of the housing 104 below the seating shoulder 136. The one or more keys 150 can have a lobular shape. The one or more keys 150 each engage a complementary-shaped recess (not shown) in the valve body 138 to prevent rotation of the housing 104 relative to the valve body 138 after the valve cartridge 100 is installed.

The lower opening 128 in the housing 104 defines a water inlet passage 152 that allows the (cold or hot) water to flow into the valve cartridge 100. The lower portion 134 of the housing 104 includes one or more water outlet passages 154 formed therein. As shown in FIG. 8A, the valve cartridge 100 includes two water outlet passages 154 formed in opposing sides of the lower portion 134 of the housing 104. The water outlet passages 154 have rounded edges 156 that increase the flow rate of the water through the water outlet passages 154, which contributes to an increased flow rate of the valve cartridge 100. When the valve cartridge 100 is installed in the valve body 138, only one of the water outlet passages 154 of the housing 104 will align with a corresponding water outlet passage 158 of the valve body 138, such that the other one of the water outlet passages 154 of the housing 104 is blocked by a wall 160 of the valve body 138 (see FIGS. 10A-10B).

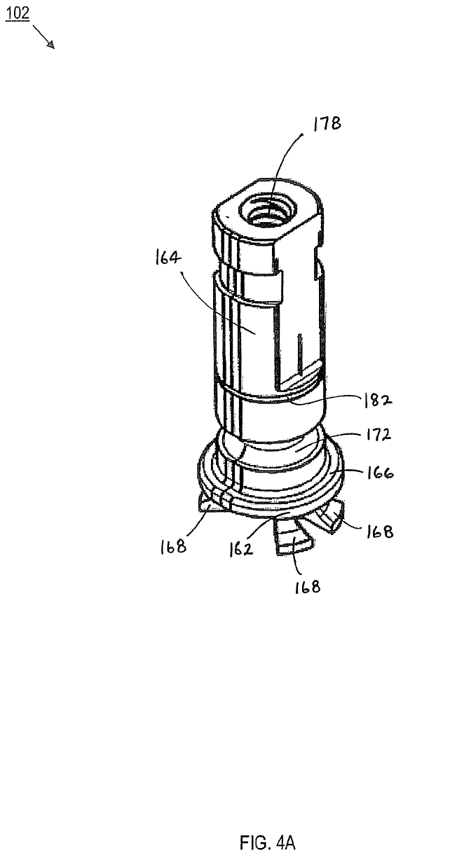

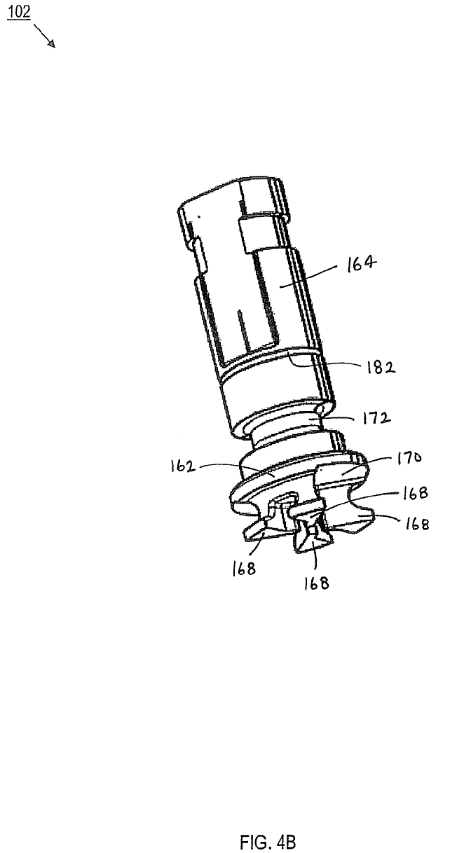

As shown in FIGS. 4A-4B, the stem 102 is the actuating mechanism for the valve cartridge 100. The stem 102 includes a flat portion 162 and a shaft portion 164. The shaft portion 164 of the stem 102 extends from and is perpendicular to the flat portion 162 of the stem 102. The flat portion 162 and the shaft portion 164 can be discrete components or can be formed integrally. The flat portion 162 has a diameter that is substantially the same as the diameter of the cavity 126 in the housing 104 below the groove 144 but greater than the diameter of the cavity 126 in the housing 104 above the groove 144. Accordingly, the flat portion 162 cannot fit past the second inner ledge 148 in the cavity 126 of the housing 104. The washer 110 fits over the shaft portion 164 of the stem 102 and rests on an upper surface 166 of the flat portion 162 of the stem 102. When the valve cartridge 100 is assembled, the washer 110 fits between the flat portion 162 of the stem 102 and the second inner ledge 148 in the housing 104 (see FIGS. 8D-8E). In this manner, the washer 110 acts as a bearing surface between the stem 102 and the housing 104.

The flat portion 162 of the stern 102 includes four projections 168 extending from a lower surface 170 of the flat portion 162. The projections 168 act as a coupling device for connecting the stem 102 to the sealing disk 112, as described below. The flat portion 162 and the projections 168 can be discrete components or can be formed integrally.

The shaft portion 164 of the stern 102 includes a groove 172 for receiving an internal seal 174 (e.g., an O-ring). The internal seal 174 forms a water tight seal between an inner surface 176 of the housing 104 and the stem 102 (see FIGS. 8D-8E and 10A-10B). The shaft portion 164 of the stem 102 also includes an internal threaded bore 178. The operating member 180 such as a handle, knob or the like (see FIGS. 10A-10B) can be connected to the shaft portion 164 via the internal threaded bore 178, thereby facilitating manipulation of the stem 102 by the user.

The shaft portion 164 of the stem 102 also includes a recess 182 formed on a periphery of the shaft portion 164. The recess 182 allows the snap retainer 142 to engage the stem 102, as described below.

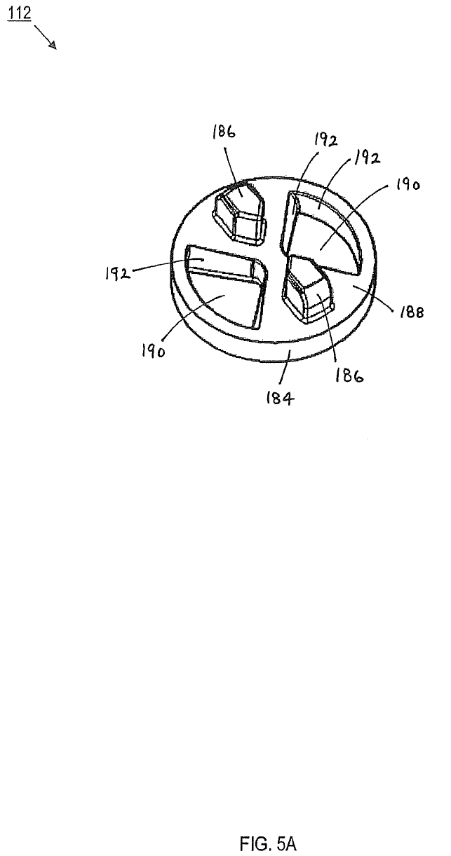

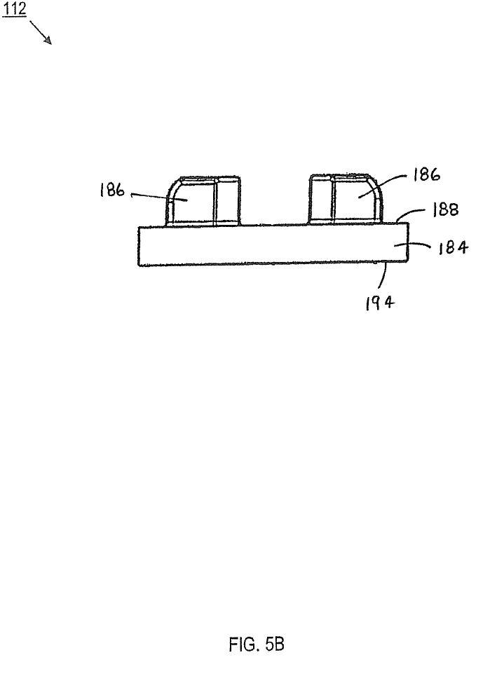

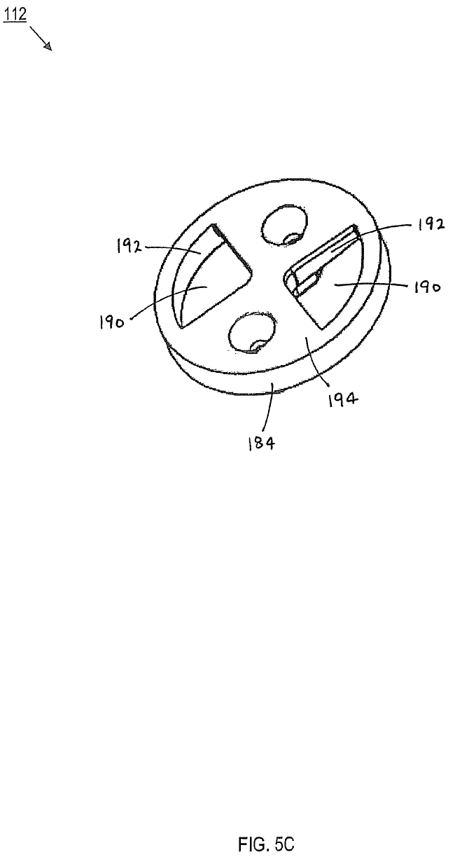

As shown in FIGS. 5A-5C, the sealing disk 112 is a valve member formed as a plate, disk or the like that can move relative to the housing 104. The sealing disk 112 includes a flat portion 184 and a pair of raised portions 186. The raised portions 186 of the sealing disk 112 rise from an upper surface 188 of the flat portion 184 of the sealing disk 112. A pair of water inlet apertures 190 are formed across from one another in the flat portion 184 of the sealing disk 112. The water inlet apertures 190 in the sealing disk 112 have a wedge shape. Accordingly, each of the water inlet apertures 190 has three walls 192. At least one of the walls 192 of each of the water inlet apertures 190 is angled/beveled from the upper surface 188 of the flat portion 184 of the sealing disk 112 to a lower surface 194 of the flat portion 184 of the sealing disk 112. The walls 192 that are angled/beveled increase the flow rate of the water through the water inlet apertures 190 in the sealing disk 112, which contributes to an increased flow rate of the valve cartridge 100.

The lower surface 194 of the flat portion 184 of the sealing disk 112 forms a sealing surface that can cover and uncover a pair of water inlet apertures 196 in the fixed disk 114 to control the flow of the (cold or hot) water through the fixed disk 114 and into the valve cartridge 100. Thus, the water flowing into the valve cartridge 100 through the water inlet passage 152 can flow through the water inlet apertures 196 in the fixed disk 114 and the water inlet apertures 190 in the sealing disk 112 and then flow out the one or more water outlet passages 154 formed in the housing 104. As the water flows out of the valve cartridge 100, it travels through a water delivery pipe 198 of the valve body 138 to a plumbing fixture 200 (see FIGS. 10A-10B).

Each of the raised portions 186 of the sealing disk 112 fits between a pair of the projections 168 of the flat portion 162 of the stem 102. In this manner, the actuating mechanism (i.e., the stem 102) and the sealing disk 112 are connected, such that rotation of the shaft portion 164 of the stem 102 by the user causes the sealing disk 112 to rotate. Accordingly, the water inlet apertures 190 in the sealing disk 112 can be rotated between states of full alignment, partial alignment and no alignment with the water inlet apertures 196 in the fixed disk 114, thereby controlling the flow rate of the water through the valve cartridge 100.

When the stem 102 and the sealing disk 112 are connected in this manner, three channels 202 are formed in the cavity 126 in the housing 104 between the flat portion 162 of the stem 102 and the flat portion 184 of the sealing disk 112 (see FIG. 8E). As noted above, when the valve cartridge 100 is installed in the valve body 138, one of the water outlet passages 154 of the housing 104 is aligned with the corresponding water outlet passage 158 of the valve body 138, such that the other one of the water outlet passages 154 of the housing 104 is blocked by the wall 160 of the valve body 138 (see FIGS. 10A-10B). The channels 202 represent an internal cross flow passage.

Although the present exemplary embodiment is described as having three channels 202, it will be appreciated that one or more channels 202 can form the internal cross flow passage. Accordingly, the water flowing through the water inlet aperture 190 in the side of the sealing disk 112 near the blocked water outlet passage 154 of the housing 104 can flow through the channels 202 to the water outlet passage 154 of the housing 104 that is aligned with the water outlet passage 158 of the valve body 138. The internal cross flow passage (i.e., the channels 202) contribute to an increased flow rate of the valve cartridge 100.

In another exemplary embodiment, the valve cartridge 100 includes an external cross flow passage in addition to or instead of the internal cross flow passage. The external cross flow passage can be formed as a recess (not shown) on the outer surface of the lower portion 134 of the housing 104 between the water outlet passages 154 of the housing 104. The external cross flow passage (i.e., the recess) allows the water flowing through the water inlet aperture 190 in the side of the sealing disk 112 near the blocked water outlet passage 154 of the housing 104 to flow through the blocked water outlet passage 154, through the recess and around the valve cartridge 100 (i.e., between the valve body 138 and the outer surface of the housing 104) where it can flow through the water outlet passage 158 of the valve body 138. The external cross flow passage contributes to an increased flow rate of the valve cartridge 100.

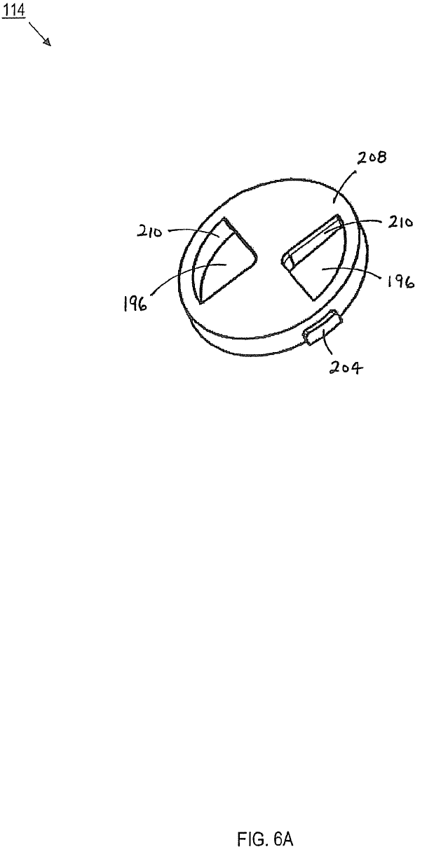

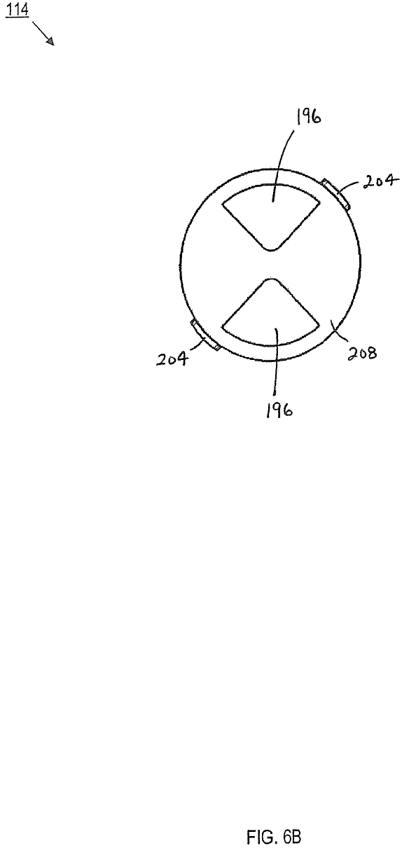

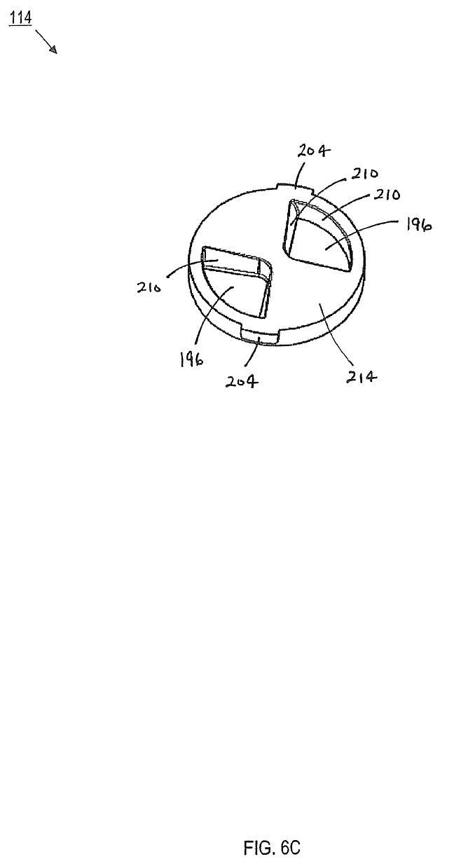

As shown in FIGS. 6A-6C, the fixed disk 114 is a valve member formed as a plate, disk or the like that is fixed relative to the housing 104. The fixed disk 114 includes one or more projections 204 formed on a periphery of the fixed disk 114. Each of the projections 204 fits inside a notch 206 formed in the inner surface of the housing 104 (see FIG. 3C), thereby preventing rotation of the fixed disk 114 within the housing 104. The fixed disk 114 includes an upper surface 208 in which the water inlet apertures 196 are formed across from one another. The water inlet apertures 196 in the fixed disk 114 allow the water flowing into the valve cartridge 100 through the water inlet passage 152 in the housing 104 to reach the sealing disk 112. The water inlet apertures 196 in the fixed disk 114 have a wedge shape. Accordingly, each of the water inlet apertures 196 has three walls 210. At least one of the walls 210 of each of the water inlet apertures 196 is angled/beveled from the upper surface 208 of the fixed disk 114 to a lower surface 212 of the fixed disk 114. The walls 210 that are angled/beveled increase the flow rate of the water through the water inlet apertures 196 in the fixed disk 114, which contributes to an increased flow rate of the valve cartridge 100.

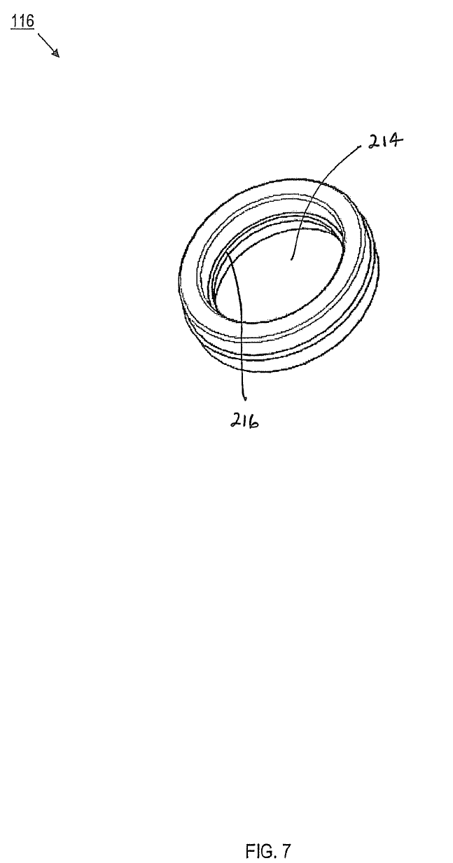

As shown in FIG. 7, the base seal 116 is a sealing member formed of an elastic material (e.g., rubber). The base seal 116 is inserted into the cavity 126 of the housing 104 through the lower opening 128 and abuts the fixed disk 114. The base seal 116 has an annular shape with a central opening 214 that allows water to flow through the base seal 116 and into the housing 104 through the water inlet passage 152. An outer diameter of the base seal 116 is slightly greater than the diameter of the cavity 126 in the lower portion 134 of the housing 104 near the lower opening 128. Accordingly, the base seal 116 is radially compressed when inserted into the housing 104, such that the base seal 116 stays firmly seated in the housing 104 and assists in securing the components of the valve cartridge 100 therein.

The base seal 116 can include an insert 216 that strengthens the base seal 116 by resisting radial compression or deformation of the base seal 116 while allowing axial compression or deformation of the base seal 116. The insert 216 can have an annular shape. The insert 216 is made of a material that is more rigid than a material of the base seal 116. The insert 216, for example, can be made of metal. Alternatively, the base seal 116 can be formed of a rigid material (or composition of materials) that strengthens the base seal 116 to resist radial compression or deformation of the base seal 116 while allowing axial compression or deformation of the base seal 116. Use of the insert 216 and/or the rigid material allows the base seal 116 to be thinner. A thinner base seal 116 increases the flow rate of the water through the base seal 116 and the water inlet passage 152 of the housing 104, which contributes to an increased flow rate of the valve cartridge 100.

A portion 218 of the base seal 116 extends out of the housing 104 through the lower opening 128 (see FIGS. 8A-8B and 8D-8E). This portion 218 of the base seal 116 is compressed axially when the valve cartridge 100 is installed in the valve body 138 (see FIGS. 10A-10B). In particular, as a retention nut 220 is tightened down and engages the upper portion 132 of the housing 104, the base seal 116 is squeezed between a seating surface of the valve body 138 and the fixed disk 114 of the valve cartridge 100 (see FIGS. 10A-10B). It should be noted that although the projections 204 of the fixed disk 114 prevent the fixed disk 114 from rotating within the housing 104, the projections 204 nonetheless allow the fixed disk 114 to move axially within the housing 104. In this manner, the axial compression of the base seal 116 exerts a loading force on the sealing disk 112 and the fixed disk 114. Accordingly, the sealing disk 112 and the fixed disk 114 are kept in water-tight engagement with one another, after installation of the valve cartridge 100.

The orientation of the sealing disk 116 relative to the fixed disk 114 is controlled by the stem 102 projecting out of the housing 104 through the upper opening 130. The operating member 180 (see FIGS. 10A-10B) is connected to the stem 102 to facilitate manipulation of the stem 102 by the user. Accordingly, after the valve cartridge 100 is installed in the valve body 138, the user can manipulate the operating member 180 which rotates the stem 102 to change the orientation of the sealing disk 112 relative to the fixed disk 114, thereby controlling the flow rate of the water flowing through the valve cartridge 100 and out the plumbing fixture 200 (see FIGS. 10A-10B).

A range of rotation of the stem 102 is limited by the stop projections 120 of the temperature limit device 108 contacting the stop tabs 124 of the housing 104. In particular, when a diagonally opposed pair of the stop ends 122 of the stop projections 120 contacts the stop tabs 124 of the housing 104, the valve cartridge 100 has a minimum flow rate (i.e., a flow rate of 0). Conversely, when another diagonally opposed pair of the stop ends 122 of the stop projections 120 contacts the stop tabs 124 of the housing 104, the valve cartridge 100 has a maximum flow rate (e.g., a flow rate of 13.4 GPM at 60 psig).

Insertion (i.e., friction fitting) of the base seal 116 in the lower opening 128 of the housing 104 during assembly of the valve cartridge 100 may be insufficient to prevent the internal components of the valve cartridge 100 from becoming dislodged from the housing 104 of the valve cartridge 100 prior to installation of the valve cartridge 100 in the valve body 138. For example, if the valve cartridge 100 is dropped from a height such that the shaft portion 164 of the stem 102 is subjected to a force, the force can move the stem 102 down in the housing 104 against the other internal components (including the base seal 116) of the valve cartridge 100, thereby overcoming the friction fit of the base seal 116 in the housing 104. As a result, the internal components (including the stem 102) can be dislodged from the housing 104 of the valve cartridge 100. Accordingly, the valve cartridge 100 has integral structure that retains the stem 102 in the housing 104 after assembly of the valve cartridge 100. The integral structure resists axial movement of the stem 102 down in the housing 104 against the other internal components of the valve cartridge 100. The integral structure includes the snap retainer 142 formed on the housing 104 and the recess 182 formed on the stem 102 (see FIGS. 9A-9B).

In one exemplary embodiment, the snap retainer 142 is formed as a plurality of discrete flanges 222 that extend from the inner surface 176 of the housing 104 into the central bore 106 of the housing 104 (see FIGS. 3D and 9A-9B). The flanges 222 are evenly spaced around a perimeter of the central bore 106. The flanges 222 act as cantilevers and are able to flex to and from the housing 104. While the stem 102 is being inserted into the housing 104 during assembly of the valve cartridge 100, the stem 102 deflects the flanges 222 toward the housing 104 (and away from the stem 102) until the flanges 222 are aligned with the recess 182 formed on the stem 102. Then, an end portion 224 of each of the flanges 222 flexes toward and comes to rest in the recess 182 of the stem 102. In this manner, the stem 102 is snap fit into the housing 104. Thereafter, a force required to dislodge the stem 102 from the housing 104 is greater than a force likely to be exerted on the stem 102 after assembly of the valve cartridge 100 and prior to installation of the valve cartridge 100 in the valve body 138, such as a force resulting from the valve cartridge 100 being dropped from a height. Accordingly, the snap retainer 142 engaging the recess 182 prevents the stem 102 from inadvertently becoming dislodged from the housing 104 after assembly of the valve cartridge 100.

In another exemplary embodiment, a single flange 222 forms the snap retainer. For example, the snap retainer 142 can be formed as a single annular flange (not shown) that extends from the inner surface 176 of the housing 104 into the central bore 106 of the housing 104. The annular flange is formed around the perimeter of the central bore 106. Furthermore, the snap retainer 142 can be formed on the stem 102 and the recess 182 can be formed on the inner surface 176 of the housing 104.

In one exemplary embodiment, a height of the end portions 224 of the flanges 222 of the snap retainer 142 is between 0.007 and 0.015 inches. In another exemplary embodiment, the height of the end portions 224 of the flanges 222 is approximately equal to 0.011 inches.

In one exemplary embodiment, a height of the recess 182 formed in the stem 102 is between 0.021 and 0.029 inches. In another exemplary embodiment, the height of the recess 182 formed in the stem 102 is approximately equal to 0.025 inches.

The snap retainer 142 also absorbs tolerances attributable to dimensional variations in the stem 102 and/or the housing 104. For example, if a diameter of the stem 102 (and, thus, the recess 182) increases or decreases, the flanges 222 of the snap retainer 142 flex toward or away from the housing 104, respectively, to compensate for the variation in the diameter of the stem 102. In this manner, the snap retainer 142 absorbs the tolerances of the stem 102 and/or the housing 104 in the valve cartridge 100. These tolerances can arise due to the manufacturing process of the stem 102 and/or the housing 104, the wear of the stem 102 and/or the housing 104 over time, etc.

A diameter of the stem 102 must be smaller than a diameter of the central bore 106 of the housing 104 so that the stem 102 can be installed in the cavity 126 through the central bore 106 and can rotate within the central bore 106 during operation of the valve cartridge 100. Consequently, a gap g exists between the stem 102 and the inner surface 176 of the housing 104 (see FIG. 9B), wherein the gap g defines a clearance between the stem 102 and the housing 104. During operation of the valve cartridge 100, the stem 102 only needs to rotate in the housing 104 to adjust the orientation of the sealing disk 112 relative to the fixed disk 114, thereby controlling the flow rate of the water through the valve cartridge 100. The clearance, however, allows the stem 102 to move radially relative to the housing 104, which results in an inconsistent, imprecise and/or loose feel during operation of the valve cartridge 100.

The snap retainer 142, however, eliminates the clearance between a portion of the stem 102 and a portion of the inner surface 176 of the housing 104 of the valve cartridge 100. In particular, the clearance is eliminated at locations where the end portions 224 of the flanges 222 of the snap retainer 142 engage the recess 182 of the stem 102. Furthermore, the end portions 224 of the flanges 222 remain engaged with the recess 182 of the stem 102 during any radial movement of the stem 102 relative to the housing 104, such that the flanges 222 limit the radial movement of the stem 102 relative to the housing 104. Accordingly, the user experiences a precise and/or smooth feel during operation of the valve cartridge 100. Since the elimination of the clearance by the snap retainer 142 is maintained as the components of the valve cartridge 100 become worn, a consistent feel is achieved over the life of the valve cartridge 100.

As discussed above, the valve cartridge 100 includes integral structure (e.g., the snap retainer 142 and the recess 182) that retains the stem 102 in the housing 104 after the valve cartridge 100 is assembled, without requiring the manufacture and assembly of additional components in the valve cartridge 100. Furthermore, the integral structure absorbs tolerances and eliminates a clearance that would otherwise affect the feel the user experiences during operation of the valve cartridge 100. In this manner, the integral structure limits movement (e.g., axial and/or radial movement) of the stem 102 relative to the housing 104.

The above description of specific embodiments has been given by way of example. From the disclosure given, those skilled in the art will not only understand the general inventive concept and its attendant advantages, but will also find apparent various changes and modifications to the structures and methods disclosed. For example, the general inventive concept encompasses placement of the snap retainer (e.g., the flange(s)) on the actuating mechanism (e.g., the stem) and formation of the corresponding recess in the housing. As another example, the flange(s) need not have a cantilever shape but can be any structure capable of deflecting (e.g., radially) and returning to its original position. It is sought, therefore, to cover all such changes and modifications as fall within the spirit and scope of the general inventive concept, as defined herein, and equivalents thereof.

1. A shell for housing dynamic sealing elements operable to control a flow rate of a fluid, the shell comprising an upper opening operable for an actuating mechanism to extend therethrough and a cavity operable to receive the dynamic sealing elements and at least a portion of the actuating mechanism, wherein a flange is formed integrally with the shell and extends into the cavity, the flange being operable to interface with the actuating mechanism to limit movement of the actuating mechanism relative to the shell.

2. The shell of claim 1, further comprising a plurality of discrete flanges formed integrally with the shell and extending into the cavity, each of the flanges being operable to interface with the actuating mechanism.

3. The shell of claim 2, wherein the flanges are evenly spaced around a perimeter of the cavity.

4. The shell of claim 1, wherein the flange is an annular flange that substantially extends around a perimeter of the cavity.

5. The shell of claim 1, wherein the flange includes an end portion, the end portion being operable to interface with the actuating mechanism.

6. The shell of claim 5, wherein a height of the end portion is between 0.007 and 0.015 inches.

7. The shell of claim 6, wherein a height of the end portion is approximately 0.011 inches.

8. A valve cartridge for controlling a flow rate of a fluid, the valve cartridge comprising:
a housing;
an actuating mechanism; and
a fluid control member,
wherein a cavity is formed in the housing,
wherein the fluid control member is disposed in the cavity of the housing,
wherein a portion of the actuating mechanism is disposed in the cavity of the housing and a portion of the actuating mechanism extends through an upper opening in the housing,
wherein movement of the actuating mechanism moves the fluid control member to vary the flow rate of the fluid,
wherein a flange is formed integrally with the housing and extends into the cavity,
wherein the actuating mechanism includes a recess, and
wherein the flange interfaces with the recess to limit movement of the actuating mechanism relative to the housing.

9. The valve cartridge of claim 8, wherein the flange remains interfaced with the recess during any radial movement of the actuating mechanism relative to the housing.

10. The valve cartridge of claim 8, further comprising a plurality of discrete flanges formed integrally with the housing and extending into the cavity, each of the flanges being operable to interface with the actuating mechanism.

11. The valve cartridge of claim 10, wherein the flanges are evenly spaced around a perimeter of the cavity.

12. The valve cartridge of claim 8, wherein the flange is an annular flange that substantially extends around a perimeter of the cavity.

13. The valve cartridge of claim 8, wherein the recess is an annular recess that substantially extends around a perimeter of the actuating mechanism.

14. The valve cartridge of claim 8, wherein a height of the recess is between 0.021 and 0.029 inches.

15. The valve cartridge of claim 14, wherein the height of the recess is approximately 0.025 inches.

16. The valve cartridge of claim 8, wherein the flange includes an end portion, the end portion being operable to interface with the recess of the actuating mechanism.

17. The valve cartridge of claim 16, wherein a height of the end portion is between 0.007 and 0.015 inches.

18. The valve cartridge of claim 17, wherein the height of the end portion is approximately 0.011 inches.

19. A valve cartridge for controlling a flow rate of a fluid, the valve cartridge comprising:
a housing;
an actuating mechanism; and
a fluid control member,
wherein a cavity is formed in the housing,
wherein the fluid control member is disposed in the cavity of the housing,
wherein a portion of the actuating mechanism is disposed in the cavity of the housing and a portion of the actuating mechanism extends through an upper opening in the housing,
wherein movement of the actuating mechanism moves the fluid control member to vary the flow rate of the fluid,
wherein a flange is formed integrally with the portion of the actuating mechanism disposed in the cavity of the housing,
wherein the housing includes a recess, and
wherein the flange interfaces with the recess to limit movement of the actuating mechanism relative to the housing.

20. The valve cartridge of claim 19, wherein the flange remains interfaced with the recess during any radial movement of the actuating mechanism relative to the housing.
